(19) United States
(12) Patent Application Publication
(10) Pub. No.: US 2021/0280377 A1
(43) Pub. Date: Sep. 9, 2021

(54) Elastomeric Switch Cover and Method

(71) Applicant: Kelly Gauthier, Peabody, MA (US)

(72) Inventor: Kelly Gauthier, Peabody, MA (US)

(21) Appl. No.: 17/191,860

(22) Filed: Mar. 4, 2021

Related U.S. Application Data
(60) Provisional application No. 62/986,107, filed on Mar. 6, 2020.

(51) Int. Cl. H01H 9/04; B60R 13/02

(52) U.S. Cl. CPC H01H 9/04; H01H 2009/0285; H01H 2300/01; B60R 13/0243

(57) ABSTRACT

An elastomeric switch cover configured for use on automotive switch panels and a method of use is described in this application. The elastomeric switch cover prevents the intrusion of water or moisture from damaging door mounted switches in vehicles. The switch cover can easily be fitted and removed or peeled back to provide access to the protected switch panel.

### CROSS REFERENCE TO RELATED APPLICATIONS

This application claims the benefit of U.S. Provisional Patent Application No. 62/986,107 filed Mar. 6, 2020, which is hereby incorporated by reference in its entirety.

### FIELD

The present disclosure relates to covers used to protect switches, in particular, to an elastomeric cover used to protect automotive switches from water and moisture.

### BACKGROUND

Door mounted automotive switches are highly sensitive to moisture because they are commonly designed with a gap between a movable portion of the switch and the base. Through the gap, moisture and/or water can enter the switches, causing them to malfunction, requiring an expensive replacement. Door mounted automotive switches are susceptible to moisture and/or water damage because they are exposed to weather and/or atmospheric conditions when the door window is opened or when the door itself is opened.

### BRIEF SUMMARY

The present disclosure includes an elastomeric cover configured to protect door mounted automotive switches from moisture or water intrusion and a method of use. Relevant drawings are included with this disclosure.

### BRIEF DESCRIPTION OF THE SEVERAL VIEWS OF THE DRAWINGS

FIG. 1 is a perspective view of an example embodiment of the elastomeric switch cover.

FIG. 2 is a perspective view of an example embodiment of the elastomeric switch cover over door mounted automotive switches.

FIG. 3 is a perspective view of an example embodiment of the elastomeric switch cover over door mounted automotive switches while being partially peeled back.

FIG. 4 is a side view of an example embodiment of the elastomeric switch cover over door mounted automotive switches.

FIG. 5 is a perspective view of an example embodiment of the elastomeric switch cover including a raised edge near 3 edges on the upper surface.

FIG. 6 is a perspective view of the elastomeric switch cover including a raised edge near 3 edges on the upper surface and over door mounted switches.

FIG. 7 is a flow chart depicting a method of using the elastomeric switch cover over door mounted switches.

### DETAILED DESCRIPTION

The present disclosure relates to an elastomeric cover configured to cover door mounted automotive switches.

Door mounted automotive switches are susceptible to water and moisture damage because of their vicinity to the door window and because they are exposed to the elements when the door is ajar. In some embodiments, the disclosed elastomeric cover can be placed over door mounted automotive switches to deflect water and moisture, protecting the door mounted automotive switches from water induced damage. Also disclosed is a method of protecting automotive door switches by placing a removable elastomeric cover over the door switches.

Conventional door mounted switched often comprise a movable switch portion and a base fixed to a door panel. The movable switch portion and base generally have a gap to allow the movable switch portion to move relative to the base portion. This gap can allow water and moisture into the base portion of a conventional door mounted switch, causing irreversible damage. Some examples of the present disclosure cover this gap, preventing the intrusion of water or moisture into the base portion of a conventional door mounted switch.

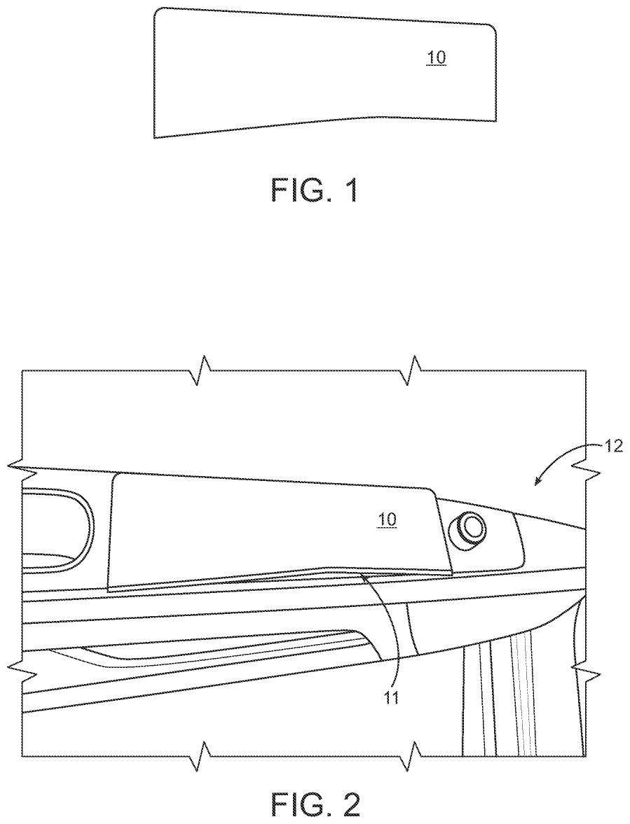

In FIG. 1 is a perspective view of an example an elastomeric switch cover 10 (hereinafter, a “cover”). The term “elastomeric” refers to the cover 10 being flexible and does not require the use of a particular material. The cover can comprise a length in a first direction that is longer than a length in a second direction. The cover can also comprise a length in a first direction that is about 2-3 times a length in a second direction. In some examples, it is preferable for the cover to comprise a length in a first direction that is about 2.5 times a length in a second direction. It has been found that a length in a first direction about 2.5 times a length in a second direction is a particularly effective ratio for covering a variety of conventional door mounted switches. The length in a first direction and the length in a second direction can be custom designed for a specific application (e.g., for a specific vehicle's door mounted switch dimensions). The cover can comprise a length in a first direction that covers the vehicle door mounted switches by about 110-150% and a length in a second direction that covers the vehicle door mounted switches by about 110-140%. Covering the door mounted switches refers to the dimensions of the movable portion of the door mounted switches when viewed from above. The term “about” as used herein refers to a value that is plus or minus 10% of the stated reference number. For example, about 110% would include 100-120%.

In FIG. 2 is a perspective view of the cover 10 over an automotive door mounted switch panel 11 (hereinafter, the “switch panel”) that is fixed to a vehicle door panel 12. The weight, size and material properties of the cover 10 allow it to be merely placed on the switch panel 11 without slipping off.

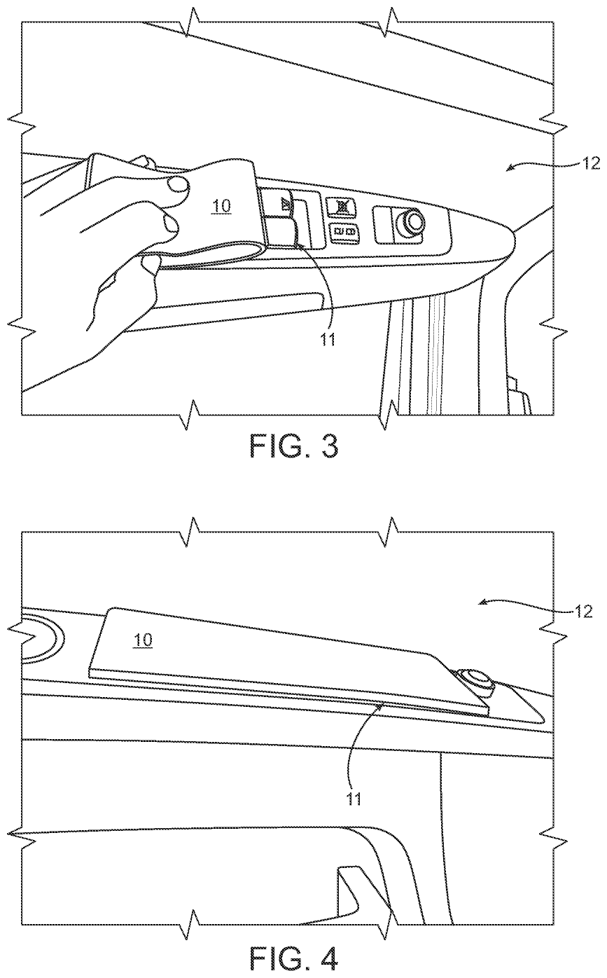

In FIG. 3 is a perspective view of the cover 10 over a switch panel 11 that is fixed to a door panel 12. In FIG. 3, the cover 10 is being peeled back by a user to reveal the variety of door mounted switches comprising the switch panel 11. In some examples, a user can peel back an edge of the cover 10 to reveal the switch panel 11. In some examples, a user can remove the cover 10 entirely to reveal the switch panel 11.

In FIG. 4 is a side view of the cover 10 over a switch panel 11 that is fixed to a door panel 12. Visible in FIG. 4 is the approximate thickness of the example embodiment of the cover 10. The cover 10 comprises a vertical thickness of about 0.1-1.0 inches, depending on the application. In some embodiments, it is preferable for the cover 10 to comprise a vertical thickness of about 0.15-0.30 inches. The cover 10 generally follows the upper surface of the switch panel 11, providing a seal against water and moisture. The cover's 10 close fit to the upper surface of the switch panel 11 also maximizes the surface contact between the bottom of the cover 10 and the upper surface of the switch panel 11 to increase the amount of friction between the cover 10 and the switch panel 11.

The cover 10 can be constructed out of an elastomeric material with adequate weight and surface friction to maintain contact with the switch panel 11 when the vehicle is in motion. In some embodiments, the cover comprises a room temperature vulcanizing (“RTV”) silicone rubber. In some embodiments, the cover 10 can include logos or patterns molded into a surface for a branding or decorative effect.

The cover 10 preferably comprises an elastomeric material with a Durometer Hardness, Shore A of about 50-70. The cover 10 more preferably comprises an elastomeric material with a Durometer Hardness, Shore A of about 55-63. The cover 10 most preferably comprises an elastomeric material with a Durometer Hardness, Shore A of about 58-60.

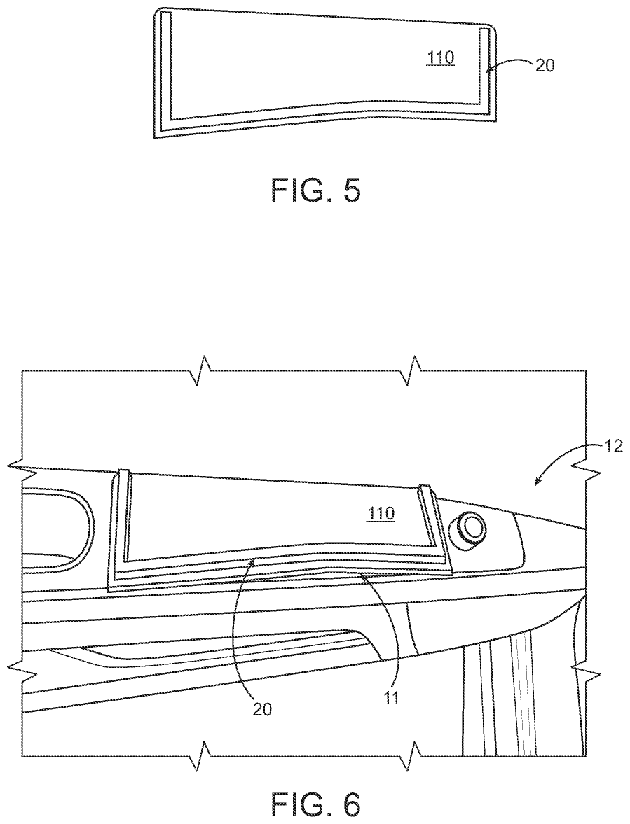

FIG. 5 is a perspective view of an example embodiment of the elastomeric switch cover 110 including a raised edge 20 near three edges on the upper surface. The elastomeric switch cover 110 is identical to the elastomeric switch cover 10, with exception to the raised edge 20 on near three edges. The raised edge is shown as a continuous feature, but it could be segmented or have a variable height or width. The raised edge 20 is configured to make the elastomeric switch cover 110 easier to grasp to either peel up a portion or remove it altogether. The raised edge can be molded with the rest of the elastomeric switch cover 110 and can be manufactured in specific heights and widths. The raised edge has been unexpectedly easily graspable when the height or width of the raised edge 20 is about 0.25 to 1.25 times the thickness of the elastomeric switch cover 110.

FIG. 6 is a perspective view of the elastomeric switch cover 110 including a raised edge 20 near three edges on the upper surface, placed in a protective position over door mounted switches 12 on a vehicle door panel 12. The raised edges are preferably placed towards the upper edges of the elastomeric switch cover 110 directed towards the front, right side and rear of the vehicle.

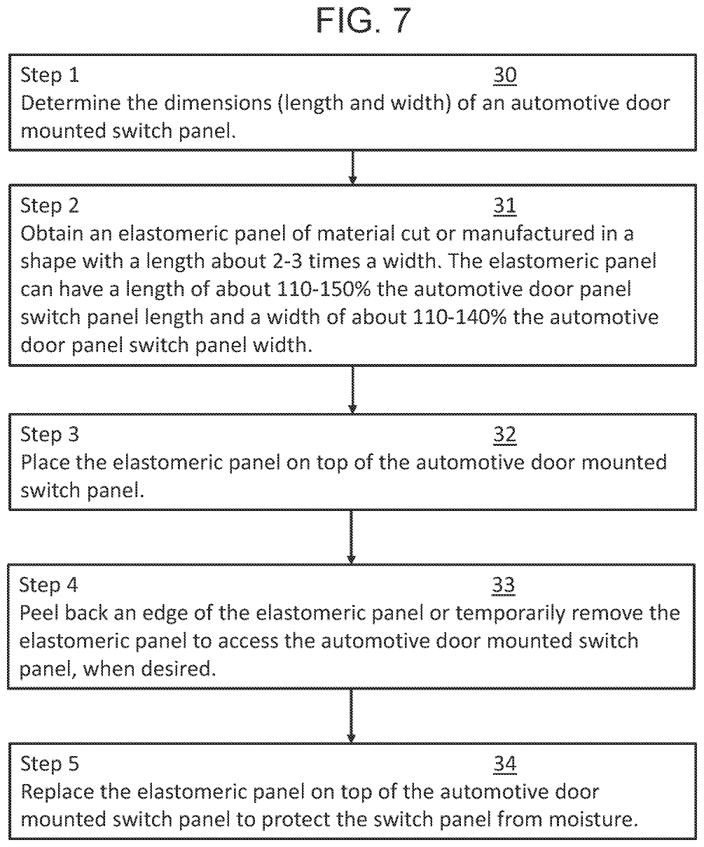

FIG. 7 is a flow chart depicting a method of using the elastomeric switch cover over door mounted switches. Step 1 30 initiates the method by determining the dimensions (length and width) of an automotive door mounted switch panel. In Step 2 31, one would obtain an elastomeric panel of material cut or manufactured in a shape with a length of about two to three times a width. The elastomeric panel can have a length of about 110-150% the automotive door panel switch panel length and a width of about 110-140% the automotive door panel switch panel width. In Step 3 32, a user places the elastomeric panel on top of the automotive door mounted switch panel, thus protecting the automotive door mounted switch panel from moisture. In Step 4 33, the user can either peel back an edge of the elastomeric panel or temporarily remove the elastomeric panel to access the automotive door mounted switch panel, when desired. In Step 5 34, the user replaces the elastomeric panel on top of the automotive door mounted switch panel to protect the switch panel from moisture. The user can repeat steps 4 and 5 as many times as needed to access the automotive door mounted switch panel. The elastomeric panel described in the aforementioned method can include a raised edge, if desired, for ease of movement.

The disclosure herein can also be described as: A method of protecting automotive door mounted switches from moisture, the steps including, determining the length and width of an automotive door mounted switch panel, where the automotive door mounted switch panel comprises at least one electrical switch, obtaining an elastomeric panel cut or manufacture in a shape with a length 2-3 times a width, placing the elastomeric panel on top of the automotive door mounted switch panel, peeling back an edge of the elastomeric panel to access the automotive door mounted switch panel, and replacing the elastomeric panel on top of the automotive door mounted switch panel. The method can include where the elastomeric panel comprises a length 110 to 150 percent the length of the automotive door mounted switch panel and the elastomeric panel comprises a width 110 to 140 percent the width of the automotive door mounted switch panel. The method can also include wherein the elastomeric panel comprises a vertical thickness of 0.1 to 1.0 inches. In some embodiments, the method can include wherein the elastomeric panel comprises at least one raised portion fixed to an upper surface, wherein the raised portion comprises a height and width that are each 0.25 to 1.25 times the vertical thickness of the elastomeric panel. The method can include wherein the elastomeric panel further comprises a material with a Durometer Hardness, Shore A of 50 to 70 and/or wherein the elastomeric panel further comprises a room temperature vulcanizing silicone rubber and a Durometer Hardness, Shore A of 58 to 60.

The disclosure also teaches an elastomeric automotive switch cover comprising: an elastomeric material shaped with a length, width and thickness, the length being 2 to 3 times the width and the thickness being 0.1 to 1.0 inches and the elastomeric material configured to temporarily cover at least one predetermined automotive switch. The elastomeric automotive switch cover can further comprise: wherein the length comprises 110 to 150 percent the length of the predetermined automotive switch and wherein the width comprises 110 to 140 percent the width of the predetermined automotive switch. The elastomeric automotive switch cover can be further defined wherein the elastomeric automotive switch comprises an elastomeric material with a Durometer Hardness, Shore A of 50 to 70. The elastomeric automotive switch cover can also be further defined wherein the elastomeric automotive switch comprises an elastomeric material with a Durometer Hardness, Shore A of 58 to 60. The elastomeric automotive switch cover can also be further defined wherein the elastomeric automotive switch comprises a room temperature vulcanizing silicone rubber.

What has been described is an elastomeric cover configured for use on automotive switch panels and a method of use. In this disclosure, there is shown and described only the preferred embodiment of the invention, but, as aforementioned, it is to be understood that the invention is capable of use in various other combinations and environments and is capable of changes or modifications within the scope of the inventive concept as expressed herein.

What is claimed is:

1. A method of protecting automotive door mounted switches from moisture:
determining the length and width of an automotive door mounted switch panel;
the automotive door mounted switch panel comprising at least one electrical switch;
obtaining an elastomeric panel cut or manufacture in a shape with a length 2-3 times a width;
placing the elastomeric panel on top of the automotive door mounted switch panel;
peeling back an edge of the elastomeric panel to access the automotive door mounted switch panel; and
replacing the elastomeric panel on top of the automotive door mounted switch panel.

2. The method of claim 1, wherein the elastomeric panel comprises a length 110 to 150 percent the length of the automotive door mounted switch panel and the elastomeric panel comprises a width 110 to 140 percent the width of the automotive door mounted switch panel.

3. The method of claim 2, wherein the elastomeric panel comprises a vertical thickness of 0.1 to 1.0 inches.

4. The method of claim 3, wherein the elastomeric panel comprises at least one raised portion fixed to an upper surface, wherein the raised portion comprises a height and width that are each 0.25 to 1.25 times the vertical thickness of the elastomeric panel.

5. The method of claim 4, wherein the elastomeric panel further comprises a material with a Durometer Hardness, Shore A of 50 to 70.

6. The method of claim 4, wherein the elastomeric panel further comprises a room temperature vulcanizing silicone rubber and a Durometer Hardness, Shore A of 58 to 60.

7. An elastomeric automotive switch cover comprising:
an elastomeric material shaped with a length, width and thickness;
the length being 2 to 3 times the width and the thickness being 0.1 to 1.0 inches; and
the elastomeric material configured to temporarily cover at least one predetermined automotive switch.

8. The elastomeric automotive switch cover of claim 7, further comprising:
wherein the length comprises 110 to 150 percent the length of the predetermined automotive switch;
wherein the width comprises 110 to 140 percent the width of the predetermined automotive switch.

9. The elastomeric automotive switch cover of claim 8, wherein the elastomeric automotive switch comprises an elastomeric material with a Durometer Hardness, Shore A of 50 to 70.

10. The elastomeric automotive switch cover of claim 8, wherein the elastomeric automotive switch comprises an elastomeric material with a Durometer Hardness, Shore A of 58 to 60.

11. The elastomeric automotive switch cover of claim 8, wherein the elastomeric automotive switch comprises a room temperature vulcanizing silicone rubber.
